(19) United States
(12) Patent Application Publication
(10) Pub. No.: US 2025/0111770 A1
(43) Pub. Date: Apr. 3, 2025

(54) BUILDING SECURITY SYSTEM, DEVICE AND METHOD

(71) Applicant: THE LOCKOUT CO., LLC, Brighton, MI (US)

(72) Inventor: Robert Couturier, Williamston, MI (US)

(21) Appl. No.: 18/902,568

(22) Filed: Sep. 30, 2024

Related U.S. Application Data
(60) Provisional application No. 63/541,786, filed on Sep. 30, 2023.

(51) Int. Cl. G08B 27/00; G08B 7/06; H04W 4/90

(52) U.S. Cl. CPC G08B 27/006; G08B 7/06; H04W 4/90

(57) ABSTRACT

A lockdown system for use in a building including one or more rooms, each having a door providing access thereto, and common areas exterior or the one or more rooms, the lockdown system including a plurality of lockdown initiation devices positionable in the building in one or more of the one or rooms and/or the common areas exterior of the one or more rooms, the plurality of lockdown initiation devices each being independently manually activatable to signal initiation of a lockdown event and to communicate, via a wireless communication network, one or more state-indicating signals indicating when the lockdown initiation device has been manually activated to signal initiation of a lockdown event, whereupon the signaled initiation of the lockdown event is communicated to at least one communication device and an alert notification of the initiation of the lockdown event is provided via the at least one communication device.

### CROSS-REFERENCE TO RELATED APPLICATIONS

The present application claims the benefit of priority to U.S. Provisional Application No. 63/541,786, filed 30 Sep. 2023, the disclosure of which is incorporated herein by reference in its entirety.

### FIELD OF THE INVENTION

The subject matter of the present application is in the field of security devices and systems of the type used in buildings, including for example schools, businesses, religious institutions, and similar institutional settings.

### BACKGROUND

Devices for “locking down” or securing individual rooms against intrusion in institutional settings have become increasingly common due to a greater threat of violence against the resident populations. Schools are a prime example of such institutions, and various methods and devices have been proposed to reliably secure schoolrooms in response to intruder alerts.

One such lockdown device is taught in U.S. Pat. Nos. 11,041,333 and 10,174,532, the disclosures of which are incorporated herein by reference in their entireties. Per these disclosures generally, an exemplary lockdown device comprising a door blocking plate has a pair of strong, spaced pins that mate with floor sockets adjacent the inside face of a door. If the door normally opens inward, the plate prevents the door from being forced inwardly from the outside. If the door normally opens outward, a bracket secured to the inside face of the door forms a large slot through which the plate is dropped to engage the floor sockets, with a portion of the plate extending above the bracket to prevent the door from being pulled open from the outside. A specialized tool can also be provided to release the installed plate from outside the door.

Systemic solutions for building lockdowns are also known. One such system, which may utilize the device of U.S. Pat. Nos. 11,041,333 and 10,174,532, is disclosed in U.S. Pat. Nos. 11,495,109 and 10,726,697, as well as U.S. Published Application No. 2023/0186748, the disclosures of which are incorporated herein by reference in their entireties. According to the system of these disclosures, in one exemplary form, initiation of a lockdown event in a building is automatically signaled when a door-securing device, such as, for instance, a lockdown device of the type described above, is moved from a non-deployed condition and/or is deployed to prevent opening of a door. The signaled initiation of the lockdown event is communicated to one or more communication devices, whereupon an alert notification of the initiation of the lockdown event is provided, via the one or more communication devices, to others within, and optionally outside of, the building. In another form, the lockdown event may be initiated by the one or more communication devices remotely effecting illumination of one or more of a plurality of smart light fixtures arranged in the building. Upon illumination, persons in the building would be made aware of the need to deploy door-blocking devices (e.g., lockdown devices of the type described above) to lock down rooms of the building.

Despite these advances in building security, there is room for improvement to render these devices and systems even more efficacious.

### SUMMARY

The present invention is a lockdown system for use in a building including one or more rooms, each having a door providing access thereto, and common areas exterior of the one or more rooms. According to the exemplary disclosure, the lockdown system comprises a plurality of lockdown initiation devices positionable in the building in one or more of the one or more rooms and/or the common areas exterior of the one or more rooms. The plurality of lockdown initiation devices are each independently manually activatable to signal initiation of a lockdown event and to communicate, via a wireless communication network, one or more state-indicating signals indicating when the lockdown initiation device has been manually activated to signal initiation of a lockdown event, whereupon the signaled initiation of the lockdown event is communicated to at least one communication device and an alert notification of the initiation of the lockdown event is provided via the at least one communication device.

Per one feature, the system includes a plurality of room lockdown components positionable in one or more of the one or more rooms, the room lockdown components comprising a door-securing device that is manually deployable to a deployed condition in which the door-securing device is manually positioned to prevent opening of the door providing access to the at least one room.

Per another feature, upon manual activation each of the plurality of lockdown initiation devices is operable to provide sounds and/or illumination to provide an audible and/or visual signal of the initiation of a lockdown event.

According to another feature, each of the lockdown initiation devices is operable to automatically and without manual activation provide an audible and/or visual signal of the initiation of a lockdown event when any one of the other lockdown initiation devices communicates, via the wireless communication network, the one or more state-indicating signals indicating that any one of the lockdown initiation device has been manually activated.

In one embodiment, the wireless communication network includes smart light fixtures positionable inside the building, the smart light fixtures operative to: (i) selectively provide illumination in one or more colors; and (ii) receive the signaled initiation of a lockdown event from the lockdown initiation devices, and in response thereto provide illumination in one of the one or more colors that has been predesignated to notify persons in the building that a lockdown event has been initiated (“the notification color”).

According to still a further feature, the plurality of lockdown initiation devices are positionable on vertical support surfaces in the building in one or more of the one or more rooms and/or the common areas exterior of the one or more rooms. Per this feature, the system further includes signage positionable on the vertical support surfaces vertically above each of the plurality of lockdown initiation devices, the signage dimensioned to extend outwardly from the vertical support surfaces so as to increase the visibility of the signage.

According to another feature, upon the signaled initiation of the lockdown event a text message is automatically sent to personal communication devices of a predefined list of recipients. The text message identifies at least an identifier of the building and an identifier of the room or common area containing the lockdown initiation device from which the lockdown was initiated.

Per a still further feature, upon the conclusion of a lockdown event a text message is automatically sent to the personal communication devices of the predefined list of recipients. The text message identifies at least an identifier of the building and an indication that the lockdown event has concluded.

According to yet another feature, upon the signaled initiation of the lockdown event notification of the initiation of the lockdown event is automatically sent to outside authorities. The notification includes an identifier of the building and an identifier of the room or common area containing the lockdown initiation device from which the lockdown was initiated.

### BRIEF DESCRIPTION OF THE DRAWINGS

FIG. 1 is a schematic diagram of a school building with a BLE mesh network comprising a BLE smart lighting grid and at least one room provided with BLE-equipped lockdown components, a primary communication and control (“PCC”) device, and a communication link to an external computer managed by outside authorities, according to an example of the inventive system.

FIG. 2 is a detailed view of the boot storage box from the system in FIG. 1, with the box being opened to remove the boot stored inside.

FIG. 3A schematically shows a system response to a room-initiated lockdown.

FIG. 3B schematically shows a system response to an administrator-initiated lockdown.

FIG. 3C schematically shows a system response to an accidental, delayed, or prank-initiated lockdown.

FIGS. 4A and 4B show detailed views of one of the floor sockets of FIG. 1 in section, in different operative states.

FIG. 5 schematically shows a lockdown status map on an administrator's smartphone, corresponding to initial boot-out and lockdown conditions in one room.

FIG. 6 is similar to FIG. 5, schematically showing the in-progress lockdown status of all rooms after the initial building-wide alert.

FIG. 7 is similar to FIG. 5, schematically showing the lockdown status map when all rooms have been locked down.

FIG. 8 schematically shows the building in a completed lockdown status, and a subsequent administrator-initiated “all clear” signal.

FIG. 9 shows one option for mounting a BLE sensor in the light fixtures comprising the “smart” lighting grid of the present invention.

FIG. 10 is a sample display screen on an external control device utilized in one embodiment of the system of the present invention.

FIG. 11 shows a further display screen on the external control device of FIG. 10.

FIG. 12 shows a still further display screen on the external control device of FIG. 10.

FIG. 13 shows one option for mounting a BLE audio sensor in a light fixture in the BLE smart lighting grid of FIG. 1.

FIG. 14 is a frontal view of the lockdown initiation device of the present disclosure.

FIG. 15 is an exploded perspective view of the lockdown initiation device of the present disclosure.

FIG. 16 depicts the contact member of the lockdown initiation device in frontal and top views.

FIG. 17 depicts a first portion of the body of the lockdown initiation device in frontal, side, perspective, and top views.

FIG. 18 depicts an embodiment wherein a lockdown initiation device is positioned inside the room of a building; the detailed image depicts signage indicating the location of the lockdown initiation device.

FIG. 19 depicts an embodiment wherein a lockdown initiation device is positioned in the common area of a building; the detailed image depicts signage indicating the location of the lockdown initiation device.

FIG. 20 depicts an embodiment where the system is operative to automatically send a text message to the personal communication devices of a predefined list of recipients outside of the building.

### DETAILED DESCRIPTION

The following terms are used herein with the given definitions:

“BLE sensor” will be used herein as shorthand for a BLE (or equivalent) wireless communication module or transceiver device with a sensing and/or signal relaying function, and “BLE” will be used to describe a physical portion of the lockdown system equipped with such a device.

“Building” should be understood to include single buildings as well as multi-building complexes. For simplicity, the example of a school building with classrooms will be referred to throughout. However, it should be understood to include other multi-room buildings where relatively defenseless populations are vulnerable to dangerous intruders, such as, by way of non-limiting example, senior care facilities, hospitals, businesses, and the like.

A “smart room lighting fixture” should be understood to comprehend a lighting fixture that is able to wirelessly receive and transmit short-range signals from and to compatible wireless devices in a building. A “smart lighting grid” should be understood to comprehend a plurality of “smart room lighting fixtures” which are arranged so as to form a network of interconnected fixtures.

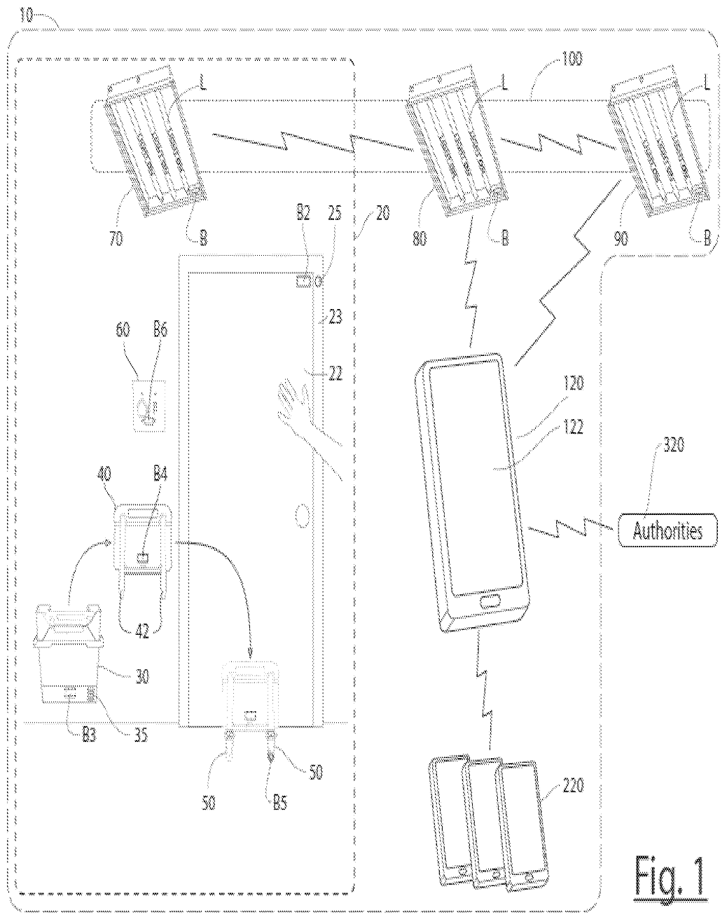

Referring first to FIG. 1, a building 10 is shown in schematic, simplified form in order to teach how to make and use the claimed invention. The building 10 which, according to the illustrated embodiment, is a school building (but which may be any building as defined above) has multiple rooms 20, e.g., classrooms, which might need to be locked down by securing their doors 22 to protect the people inside from intruders. A single room 20 with a single door 22 is shown in FIG. 1 for illustrative purposes.

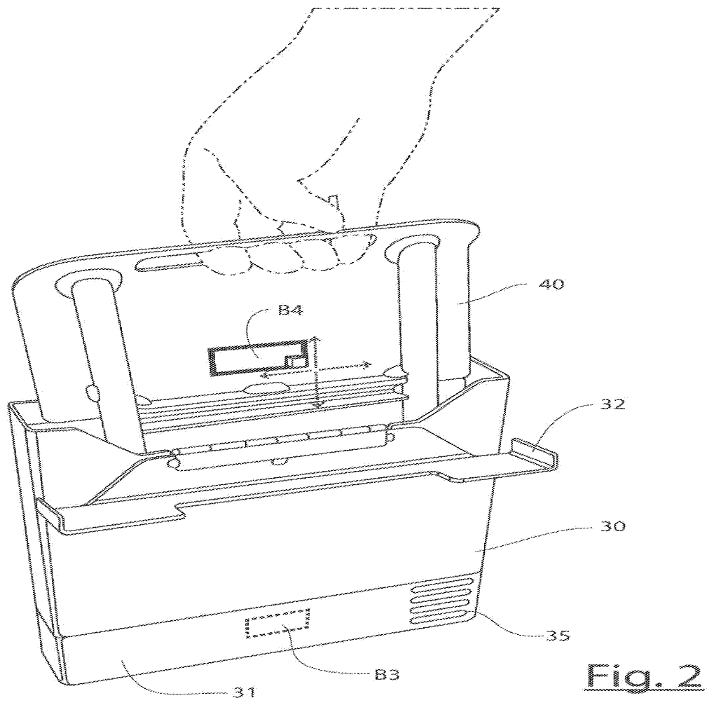

Room 20 is shown supplied with the room lockdown system components which, in the illustrated example (see also FIG. 2), include a door-securing/room lockdown device (“boot”) 40 and a storage device (“box”) 30 for storing the boot 40 in a convenient location near door 22. Box 30 may be any kind of receptacle, rack, or holder and is relatively permanently fixed in place near the door; in the illustrated example, box 30 is a fully enclosed receptacle with an upper hinged lid 32 and an audible alarm speaker 35, secured to the wall near the door. Optionally, box 30 includes a status indicator light on it to visually indicate the current status of the boot 40 as described further below.

Boot 40 in the illustrated example is a plate-like device according to the teachings of U.S. Pat. Nos. 11,041,333 and 10,174,532, issued to Couturier, having (as described above) a pair of strong pins 42 on its lower end for insertion into mating sockets 50 formed in the floor adjacent door 22.

It should be understood that boot 40 and sockets 50 are exemplary and not intended to be limiting of the present invention, according to which other room lockdown system components may be substituted.

Room 20 also includes a light switch 60 for turning a room light fixture 70 on and off. At least one light fixture 70 is associated with door 22 inside the room, by being located at or near the door 22. Light fixture 70 is equipped with a BLE sensor B of known, commercially available type that is incorporated, for example, in a driver board of one of the LED light tubes L in known manner, and is part of a “smart” lighting grid 100 formed by other BLE-equipped smart light fixtures 70, 80, and 90 throughout the building.

In the illustrated example, a BLE light fixture 80 is associated with door 22 outside the room 20 in a hallway, and at least one other “distributed” or remote BLE light fixture 90 is associated with the hallway or some other part of the building, such as, for example and not by way of limitation, the principal's office or a main administrative or security office, farther away from room 20. It should be understood that the typical building (e.g., school) will have many rooms 20, each with its own door-associated BLE light fixtures 70, 80, and different hallways, wings, or outbuildings with their own distributed BLE light fixtures 90 in wireless communication with the nearest fixtures 70, 80, and/or 90 to collectively define a wireless network for receiving and conveying signals in the manner herein described.

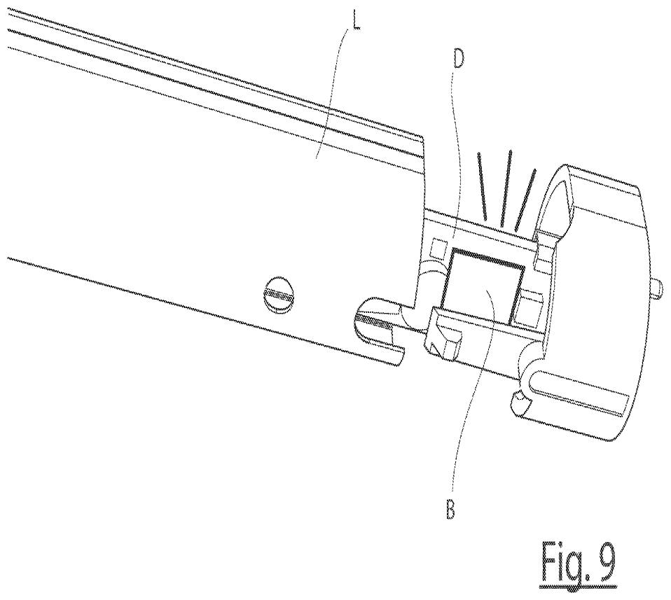

Lighting grid 100 is able to wirelessly receive and transmit short-range signals from and to compatible wireless devices in the building, starting at one or more light fixtures near the signal source and then relaying the signal(s) to the other BLE fixtures 70, 80, and 90 in grid 100 in known manner. It will be appreciated that the BLE smart light fixtures in the building define in this manner a BLE “mesh”-type network. An LED light tube with inter-fixture and intra-building communication and signal capability for such a system is disclosed in U.S. Pat. No. 10,145,516, issued Thiel, the entirety of which is incorporated herein by reference. Another example is shown in U.S. Pat. No. 8,214,084 (Ivey et al.) and titled “Integration of LED Lighting with Building Controls,” the disclosure of which is also incorporated herein by reference in its entirety. FIG. 9 illustrates an example method for mounting a BLE sensor B in one of light fixtures 70, 80, or 90 in grid 100. In FIG. 9, BLE sensor B has been mounted on the driver board D of one of the light tubes L in the fixture, as taught in the Thiel patent referenced above.

It will be appreciated that lighting grid 100 may be comprised of individual, self-contained smart light fixtures which are operative only in connection with the system herein described, rather than being conventional light fixtures incorporating a light tube that converts a conventional light fixture to utility also as a smart light fixture that also facilitates the system of the present invention. Such self-contained smart light fixtures could, per convention, be battery-powered or hard-wired to a building's electrical system.

Still referring to the exemplary embodiment of FIG. 1, the door 22, boot box 30, boot 40, at least one of floor sockets 50, and light switch 60 are also equipped with BLE sensors B2, B3, B4, B5, and B6, respectively. In the illustrated system the BLE sensors Bn are similar or identical in terms of their wireless signal-relaying function to the BLE sensors B in the light fixtures, and each is coupled to (or includes) a switch or position sensor associated with the state-variable portion of the system on which it is mounted in order to signal a change in condition or position.

For example, BLE sensor B2 may be on door 22 as illustrated, or on doorframe 23, coupled to a switch or position sensor 25 associated with the doorframe or door, so that movement of door 22 to the closed position triggers a “closed” signal from the BLE sensor B2 that is relayed to BLE sensor B in light fixture 70 and from there to other smart lighting fixtures in the smart lighting grid 100. Switch or position sensor 25 may comprise a magnetic door switch of common type, mechanically fastened or adhered to the door frame and door.

BLE sensor B3 in boot box 30 may comprise a mechanical switch that is activated by being depressed or released by boot 40 as it is inserted or removed from the box. Audible alarm speaker 35 may be a self-contained, battery-operated alarm activated by sensor B3 when the boot 40 is removed from box 30.

BLE sensor B4 on boot 40 may comprise an accelerometer type sensor activated by movement in any direction. Sensors B3 and B4 act in conjunction to detect activation of the system as a dual failsafe. The boot box sensor B3 and boot sensor B4 preferably operate independently, and do not require coordination with each other to individually initiate a lockdown. Rather, the activation of either is sufficient. The justification for this independence and redundancy is to prevent the situation where an unauthorized individual places an object in the box 30 in order to “fool” the sensor B3 into registering the presence of the boot 40 even after the boot is removed from the box. Manifestly, the accelerometer of sensor B4 on boot 40 cannot be “fooled” in this fashion and will, instead, register movement as boot 40 is withdrawn from box 30 during, or in initiation of, a lockdown.

BLE sensor B5 in one of the floor sockets 50 may comprise a magnetic proximity switch between the boot and the bottom of the floor socket. For example, when a large metal “contact” portion on the boot body nears a sensor portion on the bottom of the floor socket, sensor B5 is activated.

BLE sensor B6 in light switch 60 may comprise a common mechanical light switch activating a magnetic switch (not illustrated) in the wall behind the switch plate.

Referring to FIGS. 1-2, BLE sensor B3 in boot box 30 preferably has a master function, in that none of the state-variable component BLE sensors B2, B4, B5, or B6 is enabled or “on” until BLE sensor B3 is activated (sensors B in lighting grid 100 are always enabled). Sensor B3 is the master switch for the system and is identified as such in the system. Sensor B4 is preferably a backup or independent master switch as a failsafe measure; if sensor B4 is moved in any direction it also activates sensors B2, B5, and B6.

BLE sensor B3 is activated when boot 40 is removed from box 30, for example by mechanically decoupling the boot 40 from sensor B3 on the bottom of the box 30; once the weight of the boot is removed, the switch is released and the system is activated. Sensor B3 may be powered on by its own internal battery, or by a battery in a substation 31 in the box, to send a wireless signal to each of the other state-variable room component sensors B2, B4, B5 and B6 to enable or power them on. Simultaneously, sensor B3 signals sensor B in room light fixture 70 that boot 40 has been removed from box 30.

Once the initial boot-out signal is given by B3 in box 30 (and optionally simultaneously by sensor B4 on boot 40), the room must be locked down from the inside by blocking door 20 with boot 40.

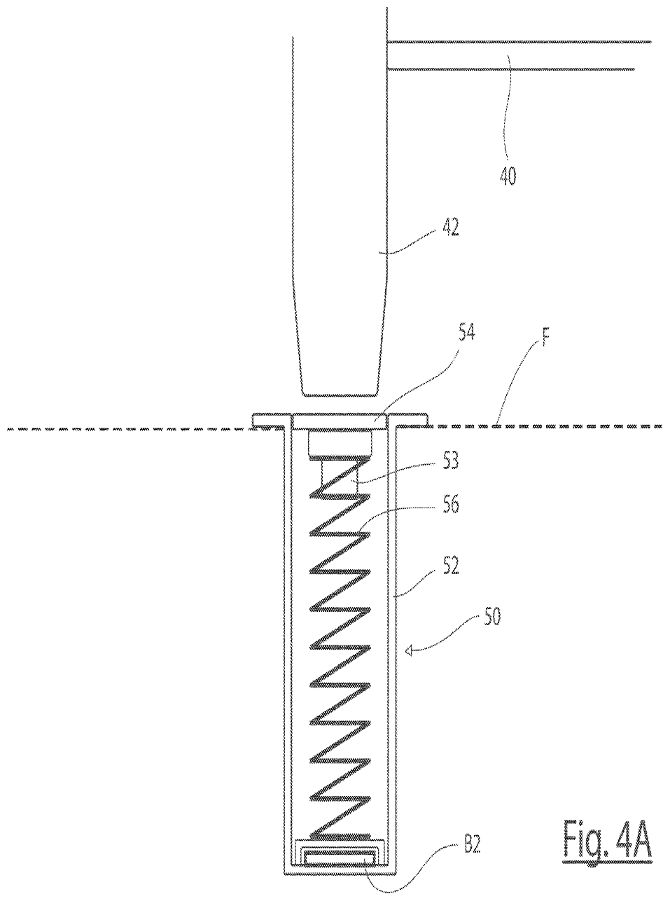

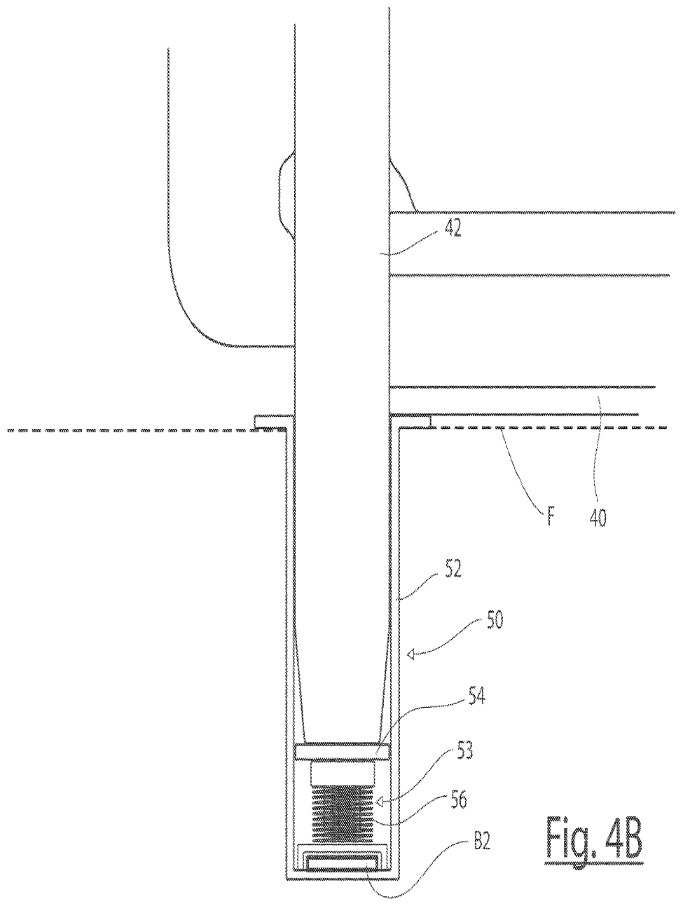

FIGS. 4A and 4B show one of the two pins 42 on boot 40 being inserted in its respective socket 50. In the illustrated example, socket 50 is a metal tube 52 mounted in a matching bore in the floor F. A plunger 54 in the socket is biased upwardly by a spring 56 to normally close off (FIG. 4A) the open upper end of tube 52. The lower end of tube includes the BLE sensor B5, and the lower end of plunger 54 includes a switch contact 53 that when coupled to sensor B5 at the bottom of the tube (FIG. 4B) causes sensor B5 to send a “boot-in-socket” signal to the lighting grid 100 through associated light fixture 70, which alone may be used to indicate that the room is locked down. The coupling of switch contact 53 and sensor B5 may take different forms, for example mechanical, direct electrical, or inductive.

The illustrated system further includes at least one primary communication and control (PCC) Bluetooth (or equivalent) compatible device 120 (e.g., a smartphone, a portable tablet computer, desktop computer, etc.) configured to communicate with at least the BLE sensors in the light fixtures of grid 100. The PCC device 120 is preferably, though not necessarily, carried by a designated person or persons of authority or responsibility in the building, such as security personnel, the school principal, etc. The signal from the BLE sensor on any fixture 70, 80, or 90 in the grid is sufficient to activate an “alert” signal on PCC device 120. For example, and without limitation, display 122 may light up with a visible alert notice, or device 120 may emit a sound or vibration, or all of the above may occur, in response to any change in status of the lockdown components.

PCC device 120 in the illustrated example is a “primary” communication and control device. As mentioned below, the PCC device may in one embodiment provide the sole gateway to and from outside security personnel (e.g., police, firefighters, and/or other first responders and designated generally as “Authorities” in FIG. 1) with respect to the BLE mesh network in the building.

In comparison, secondary wireless communication and/or control devices 220 in the hands of lower-tier personnel in the building may be limited to receiving notifications/instructions, or to two-way communication with the PCC device through the BLE mesh network. However, the secondary communication and/or control devices 220 may also, in one form of the invention, be adapted to also control the system to at least initiate a lockdown in the same manner as described with respect to the PCC device 120.

The at least one PCC device 120 (it is contemplated that more than one such “primary” communication and control device may be provided in a given building, for purposes of redundancy, to permit faster response time in the event of an intruder, etc.) can also communicate with the secondary wireless communication and/or control devices 220 in building 10, and/or with security personnel (“Authorities” in FIG. 1) 320 outside building 10, in order to alert them to a lockdown situation, to coordinate security responses, etc. These alerts may be performed manually by dialing the phone; or automatically by the PCC device 120 upon receiving a lockdown alert from one of the rooms in the building; or upon the PCC device 120 being used to send a lockdown alert to the rooms in the building. Communication between the PCC 120 and secondary 220 devices may be in conventional wireless network fashion, via the BLE mesh network herein described, or via other conventional means.

PCC device 120 may have a number of pre-entered phone numbers stored in its memory, for example key personnel in the building 10 with compatible phones (which may be the secondary communication and/or control devices 220) and/or outside security personnel 320 such as, by way of example, police and fire departments. PCC device 120 may be programmed to automatically send a voice, text, email, or similar wireless phone network alert to such personnel and authorities in response to receipt of an initial boot out (or completed lockdown) alert from the first room 20 in which a boot 40 is removed from its box 30. Alternately or additionally, PCC device 120 may be used to manually call, text, etc. the appropriate people inside and/or outside the building and alert them to the situation.

It should be understood that, within the range limits of the BLE sensors and the BLUETOOTH-compatible signal strength of the PCC device 120 communicating with the sensors, the person(s) equipped with a PCC device 120 may be able to receive and trigger lockdown alerts from adjacent exterior grounds associated with the building (e.g., parking lots, security booths, playgrounds, etc.).

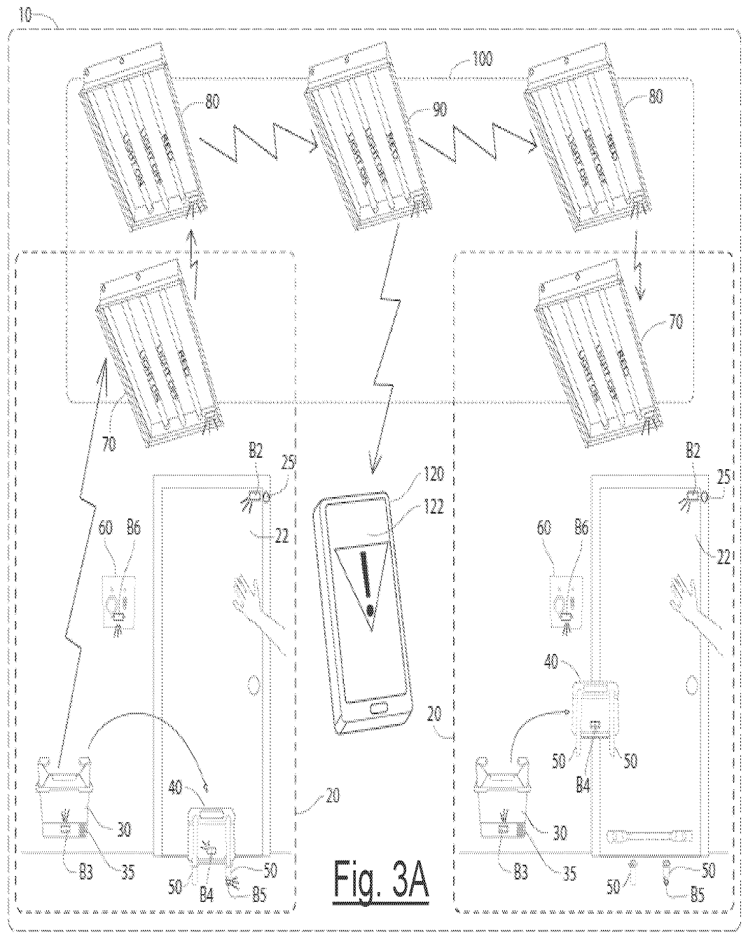

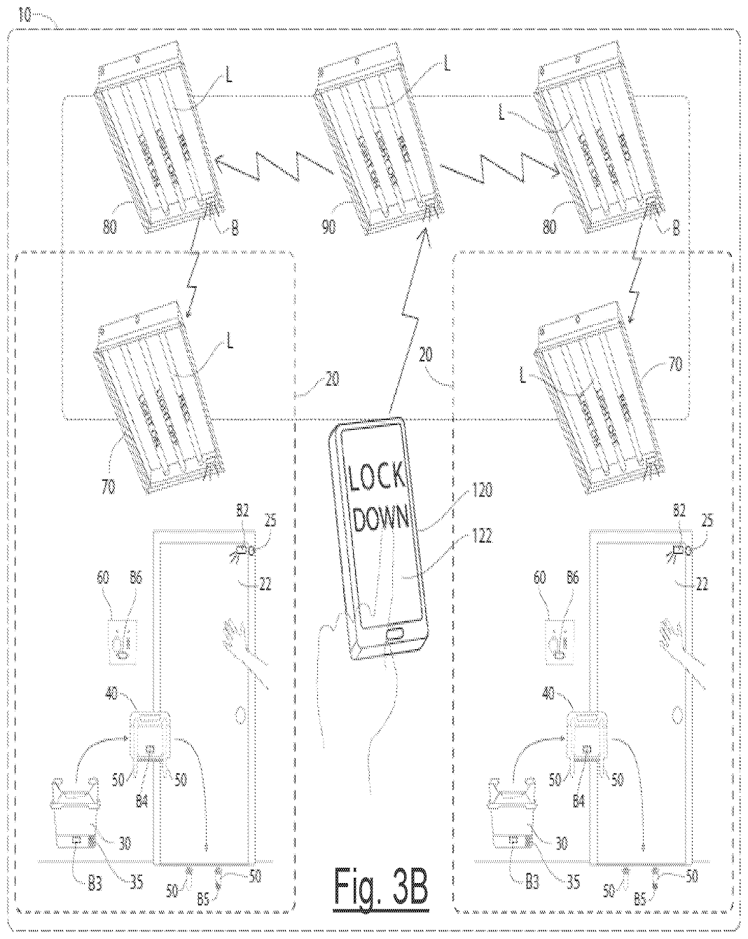

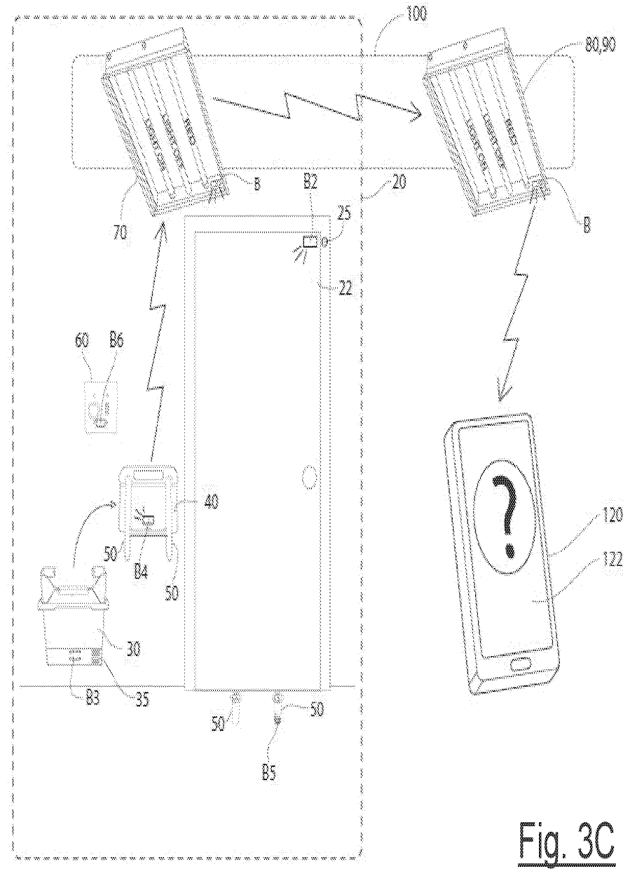

Secondary communication and/or control devices 220 may be regular smartphones, tablet computers, etc., having direct, non-BLE wireless communication (mobile phone service, email, etc.) with the primary, PCC, device 120, or they may be secondary devices 220 configured for compartmentalized or dedicated communication with the PCC device 120 and with each other through the BLE smart lighting grid 100. Generally speaking, in the event of a room-initiated lockdown (FIG. 3A), in which one of the room lockdown components is moved to trigger its BLE sensor to send a signal to BLE light fixture 70, smart lighting grid 100 sends a signal to the PCC device 120. The signal from the BLE sensor on any fixture 70, 80, or 90 in the smart lighting grid near the person carrying PCC device activates an “alert” signal on that device 120. For example, display 122 may light up with a visible alert notice, or device 120 may emit a sound or vibration, or all of the above may occur. The administrator or other responsible person is accordingly alerted that at least one room 20 has initiated a lockdown due to a threat.

More particularly, the boot 40 is pulled from box 30 by a handle, causing sensors B3 and B4 to signal sensor B in fixture 70 of the boot's “out” status, and to also wirelessly enable the other BLE sensors B2, B5, and B6 in the room's system components 22, 40, 50, and 60. This puts system component sensors B2, B5, and B6 in condition to send component state-indicating signals to the smart lighting grid 100 through sensor B in lighting fixture 70 and begins an audible “Lockdown” (or other voice warning or alarm sound) output from speaker 35 and/or the status indicator at the boot storage box 30 location.

Referring again to FIG. 1, sensor B in room light fixture 70 relays the signal to the smart light fixture 80 outside the door, which in turn signals the nearest distributed fixture 90 that boot 40 has been pulled from box 30 in room 20. This signal in turn is relayed throughout all fixtures 70, 80, and 90 in the building.

Insertion of pins 42 into sockets 50 to block the door is sufficient to complete a locked-down condition for room 20. However, referring to FIG. 3A, a further step may be required to complete the lockdown procedure, as follows: After door 22 is closed, and boot 40 is engaged with sockets 50 in the floor by inserting boot pins 42 into the sockets, light switch 60 controlling fixture 70 and optionally any other non-BLE equipped light fixtures in room 20 is turned “off”, either manually or automatically (this last step is in keeping with current lockdown protocols popular in the United States, in which the room is darkened after the door is shut and locked or barricaded). For example, BLE sensor B6 in light switch 60 may be coupled to an on/off control circuit in light switch 60 that is wirelessly responsive to sensor B5 in socket 50 to automatically turn switch 60 “off” independently of the manual light switch.

All other rooms 20 in the building 10, having been notified of the “boot-out” or other lockdown initiating component change in initiating room 20, quickly follow suit in response to the warning color change in their door-associated light fixtures 70 and 80, and also preferably by the audible alarms 35 in their boxes 30, and use the boots in their respective rooms to secure the doors thereof.

Still referring to FIG. 3A, the “boot out” signal from sensor B3 to B in fixture 70 is also relayed by B throughout the building via fixtures 80 and 90 in smart lighting grid 100. In the illustrated example, some or all of the smart light fixtures in the grid display or change lighting state to a “danger” indicating condition, for example by turning one or more of the light tubes in each fixture from white light to red light, and turning another tube off to dim the lights. At a minimum, fixtures 70 and 80 associated with each room door 22 should change color or otherwise display a “danger” lighting change, to alert those inside and immediately outside each room of the threat. In the other rooms 20 throughout building 10, the light fixture color change is an immediate and highly visible signal to pull boots 40 out of boxes 30 and barricade the doors. If only some of the distributed fixtures 90 in grid 100 are enabled to change color, they should be spread evenly throughout the building so that the greatest number of people in the building is likely to see the danger indication.

It will be appreciated that, where the lighting grid 100 is comprised of individual, self-contained smart light fixtures which are operative only in connection with the system herein described, rather than being conventional light fixtures controlled by switches, such as the switch 60, the sensor B6 may be unnecessary as the lighting of the self-contained light fixtures would be controlled via other means. However, the sensors B6 may still be optionally employed as a means of effecting a desired lockdown protocol where other lights that may be outside the lighting grid 100 are associated with switches (e.g., 60).

Still referring to FIG. 3A, smart lighting grid 100 sends a signal to the PCC device 120. The signal from the BLE sensor on any fixture 70, 80, or 90 in the grid near the person carrying PCC device activates an “alert” signal on device 120. For example, display 122 may light up with a visible alert notice, or device 120 may emit a sound or vibration, or all of the above may occur. The person carrying the PCC device 120 is accordingly alerted that at least one room 20 has initiated a lockdown due to a threat.

Referring next to FIG. 3B, there is schematically represented a lockdown via the PCC device 120; that is, a lockdown in which the PCC device 120 is used to manually send a signal to the smart lighting grid 100 through the nearest fixture 70, 80, or 90, which is then relayed through all of the fixtures in grid 100 to change their state to the lockdown-alert status (e.g., one or more light tubes in each BLE-equipped fixture goes red, one goes dark; a dedicated warning tube that was dark goes red; etc.). This provides an instant, building-wide visible alert to the teachers or other personnel in every room 20 to immediately pull boots 40 from boxes 30 and secure their doors 22 and/or to take whatever other lockdown action has been agreed on in advance. The PCC device 120 can activate the system, along with any other enabled secondary communication and/or control device 220 in the building 10, for instance using a common or shared security protocol (such as, by way of non-limiting example, a secure passcode, fingerprint or swipe (same as unlocking a smart phone)). As will be appreciated, such security measures serve to preclude unwanted or unauthorized personnel from being able to grab a device 120 or 220 and initiate a lockdown or otherwise control the system.

Turning next to FIG. 3C, there is schematically depicted the system response if boot 40 is accidentally pulled from box 30, or pulled as a prank, or otherwise not promptly inserted in floor sockets 50. A controller “substation” in box 30 may comprise a BLE module on a board with the switch B3 mounted to it. The substation may also house the audible circuitry and other smart programmable circuitry), and may also include a timer triggered by removal of boot 40 from the box. The timer is turned off by receipt of the wireless signal from BLE sensor B5 in floor socket 50 when the corresponding boot pin 42 is inserted into that socket. If the timer is not signaled to shut off within a predetermined time frame, e.g. two or three seconds, the box 30 indicates a boot-out alert as in FIG. 3A, but the BLE sensor B3 in box 30 substation 32 will relay a modified alert status to the PCC device 120 through grid 100, indicating that the boot 40 has not been placed in the sockets and that the room 20 is not locked down for some reason. The display 122 on device 120 will accordingly show a modified alert symbol or notice, as schematically shown in FIG. 3C.

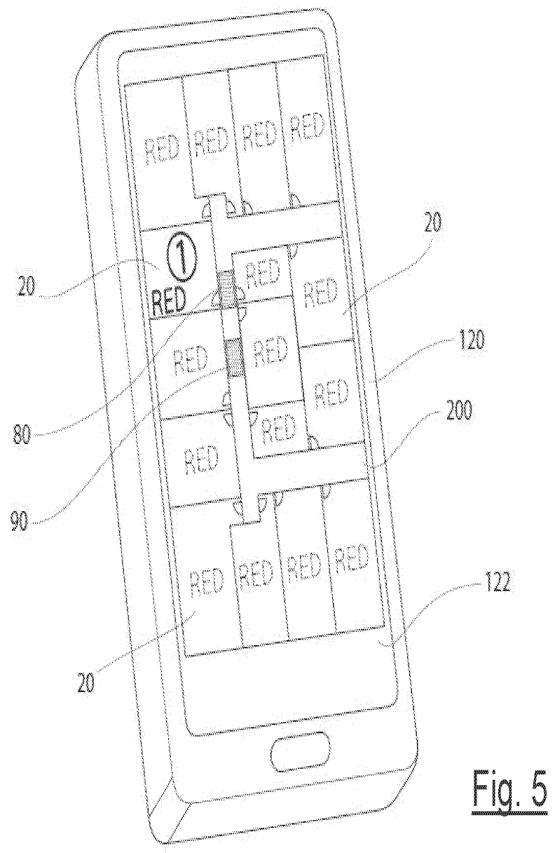

In the illustrated example, the at least one PCC device 120 is also provided with a virtual room map 200 of the school building, shown schematically in FIGS. 5-7. Map 200 may be retrieved and displayed from the device's memory manually via the touchscreen, or automatically by an app stored in the phone's memory and responsive to the alert and lockdown signals from the lighting grid 100. Upon receipt of the initial “boot out” alert or “prank” signal from a room-initiated lockdown or prank situation, the map can be displayed on screen 122 to show the lockdown status of the initiating room, for example by shading the initiating room in a dark or solid red (solid lines) as shown in FIG. 5 and optionally numerically identify and store in memory this initiating room with a mark such as “#1” for future use or reference.

After the initial boot-out alert, if the initiating room 20 is locked down within the predetermined time interval by inserting boot 40 in floor sockets 50, the status of all rooms 20 is displayed on screen 122, shaded or colored or otherwise visually marked according to lockdown status. For example, all other rooms 20 can be initially shaded a light or transparent red (shown as “RED” in shaded phantom in FIG. 5) until their respective boots 40 are inserted fully in floor sockets 50, at which point their color status would be changed to a solid or dark red.

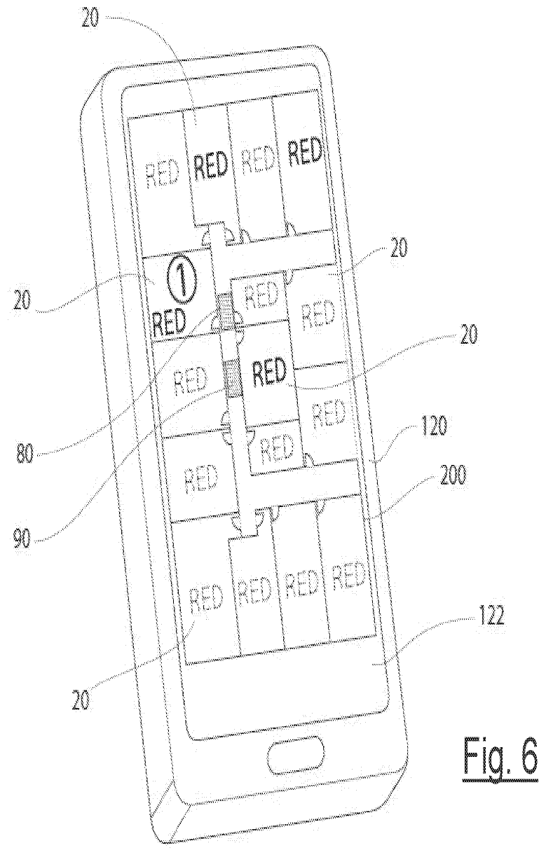

FIG. 6 shows a partial building lockdown status, with some rooms in shaded red and some in solid red, as the room's transition from a boot-out or alerted status to a locked-down status.

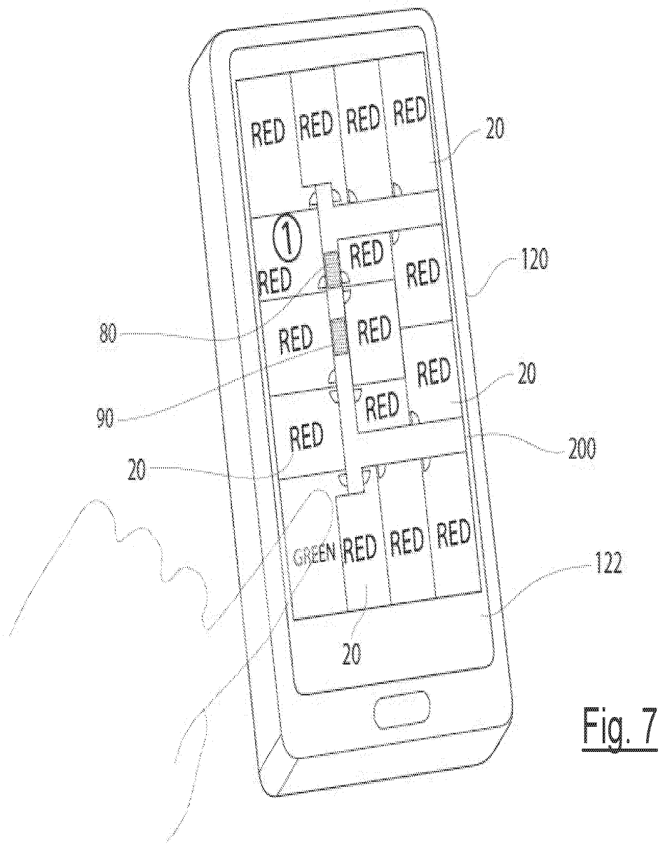

FIG. 7 shows a completed building lockdown status on map 200, with all rooms in solid red.

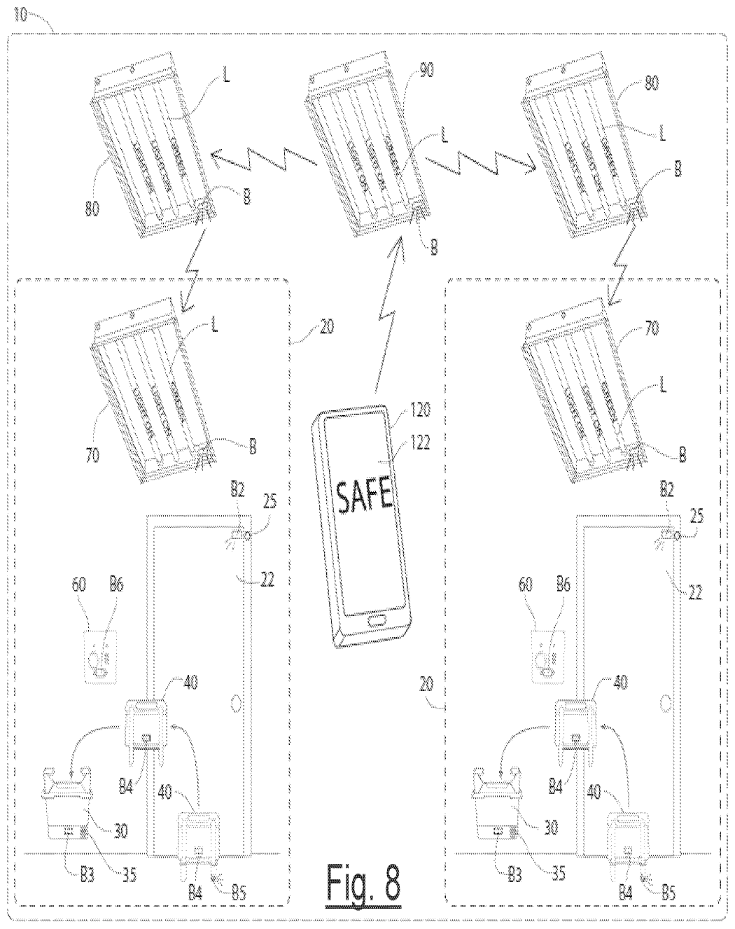

Referring now to FIG. 8, there is shown one of the light tubes in the lighting fixtures changed to a corresponding or complementary color, e.g. from red to green, letting those in the building 10 know that all rooms are properly locked down. In addition, the system can control the lighting from at least the PCC device 120 and perform a manual evacuation. The person(s) controlling the PCC device 120 can signal “all clear” from the device and all smart lights 70, 80, 90 turn green, signaling “all clear” so that rooms 20 can open their doors 22. Alternatively, the person controlling the PCC device 120 can choose manual evacuation mode, in which that person can touch the map locations or icons representing individual rooms 20 or individual light fixtures 70, 80, 90 identified on the room map 200 on the touchscreen of PCC device 120 to change to green or whatever color may be used to signal “evacuate” to people in the building, thereby releasing rooms from lockdown status and/or evacuating the building via the PCC device 120. The person controlling the PCC device 120 may even direct evacuation by altering the lighting in only certain hallways or certain parts of the building to establish preferred, clearly marked routes to the exit doors.

The ongoing progress of the lockdown as displayed on the PCC device 120 allows personnel inside and outside the building to coordinate an effective response. After all rooms 20 are locked down and the threat is cleared, the person controlling the PCC device 120 may then send an “all clear” or “safe” signal to all rooms in the building via device 120 through the lighting grid 100. As shown schematically in FIG. 8, this may result in light fixtures 70, 80, and 90 returning to a normal, non-colored, and/or more fully lit condition. In one embodiment of the invention, for example, one tube may remain green, and the previously darkened tube may be turned back on. Depending on the protocol in effect, teachers in rooms 20 may then remove boots 40 from the floor sockets 50 and open their doors, or they may shelter in place until security personnel equipped with a special tool remove boots 40 from sockets 50 from outside the rooms, as taught in the Couturier published application referenced above.

According to the system of the present invention in one embodiment thereof, the outside security personnel 320 in FIG. 1 further comprises an external communication and control device (comprehended generally by the “Authorities” box designated by reference numeral 320) disposed at a location remote from the building 10. The external communication and control device 320 is in communication with the PCC device 120, as discussed heretofore, so as to receive information therefrom respecting the status of the various lockdown components and the smart lighting grid. It is also, according to the illustrated embodiment, operative to take “pass-through” control of the PCC device, such that the external communication and control device is at least operative to receive information as to whether the room lockdown components are in the deployed (e.g., “boot out”) condition thereof, and to independently effect a change in the color of at least some of the smart light fixtures in the smart lighting grid. Broadly speaking, the external communication and control device is operative to function as the PCC device 120 as heretofore described, such that outside authorities (e.g., police, security personnel, etc.) are able to remotely effect changes in the building as needed e.g., to initiate a lockdown, to terminate a lockdown, to communicate with persons in the building, etc.

While it is contemplated in the illustrated embodiment that the external communication and control device 320 is in communication with the lockdown components and smart lighting grid via the PCC device 120, it is also contemplated that such communication may be effected by other conventional means. For instance, and without limitation, it is contemplated that the smart lighting grid and lockdown components may communicate to a networked (whether locally or via the Internet through a local server) computer which, in turn, is also in communication with each of the PCC device 120 and the external communication and control device 320.

External control of the building lockdown system via the external communication and control device 320 comprises, according to the exemplary embodiment, three communication modes: (a) visual control, wherein the outside authorities adjust visual signals such as lockdown status notifications and escape routes by selectively altering the lighting state of BLE light fixtures throughout the building, and/or by altering visual representations of the building lockdown status on PCC devices in the building; (b) two-way text messaging control through the BLE smart lighting grid, in which multiple authorized PCC devices in the hands of administrators or staff are provided with blanketed general messaging and/or individual, point-to-point messaging for the purposes of notification and/or intelligence gathering; and (c) text audio control, wherein BLE-equipped light fixtures and room lockdown components are also equipped with audio speakers for relaying text audio messages from the outside authorities through the BLE mesh network in the building.

As will be appreciated, the external communication and control device 320 may, like the other devices 120 and 220 described herein, be a phone, computer, tablet computer, etc.

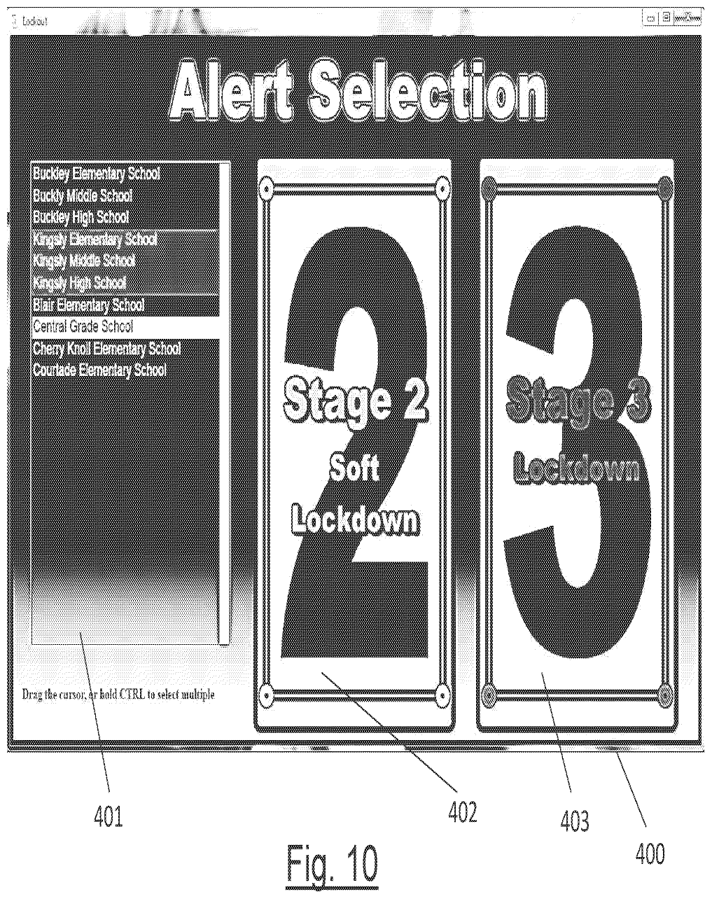

Turning next to FIGS. 10, 11, and 12 there are shown exemplary display screens on the external communication and control device 320 by which the three aforementioned communication modes may be effected. The display screens of FIGS. 10, 11 and 12 represent a useful format for outside personnel to monitor buildings (e.g., 10) under their jurisdiction for lockdown notifications from the PCC devices (e.g., 120) in the buildings (e.g., 10), as well as to initiate lockdowns in such buildings remotely.

More specifically, FIG. 10 depicts the exemplary form of an “Alert Selection” display screen 400 of the external communication and control device via which authorities can initiate a lockdown remotely. More particularly, display screen 400 includes a left-hand portion comprising a listing 401 of buildings (e.g., schools, as per the illustrated embodiment) under the jurisdiction of the authorities. One or more of these buildings may be selected, such as via a cursor, for initiation of a remote lockdown. Upon selection of one or more buildings from the listing 401, the authorities may initiate the lockdown by selecting one of the lockdown “buttons” 402 or 403.

As shown in FIG. 10, two types of lockdowns may be initiated: A “soft lockdown,” represented by “button” 402; and a “lockdown,” represented by “button” 403. In a “soft lockdown,” one or more distinctive audible or visual indicators of the type described above may be activated in the affected building to advise of the need to take appropriate measures (as agreed upon in advance) short of engaging boots 40 to barricade or secure doors 22. Such indicators may include audible signals from loudspeakers, from the speaker 35 in each box 30, etc. Indicators may also include the activation of one or more light tubes in the BLE-equipped fixtures 70, 80, 90, etc. Still further indicators may be conveyed to the secondary communication and/or control devices 220 via the authorities, including, optionally, using the PCC device 120 as a communication hub.

In a “lockdown,” by contrast, one or more distinctive audible or visual indicators of the type described above may be activated in the affected building to advise of the need to take appropriate measures (as agreed upon in advance), including engaging boots 40 to barricade doors 22. As above, such indicators may include audible signals from loudspeakers, from the speaker 35 in each box 30, etc. Indicators may also include the activation of one or more light tubes in the BLE-equipped fixtures 70, 80, 90, etc. Still further indicators may be conveyed to wireless communication devices 220 via the authorities, including, optionally, using the PCC device 120 as a communication hub.

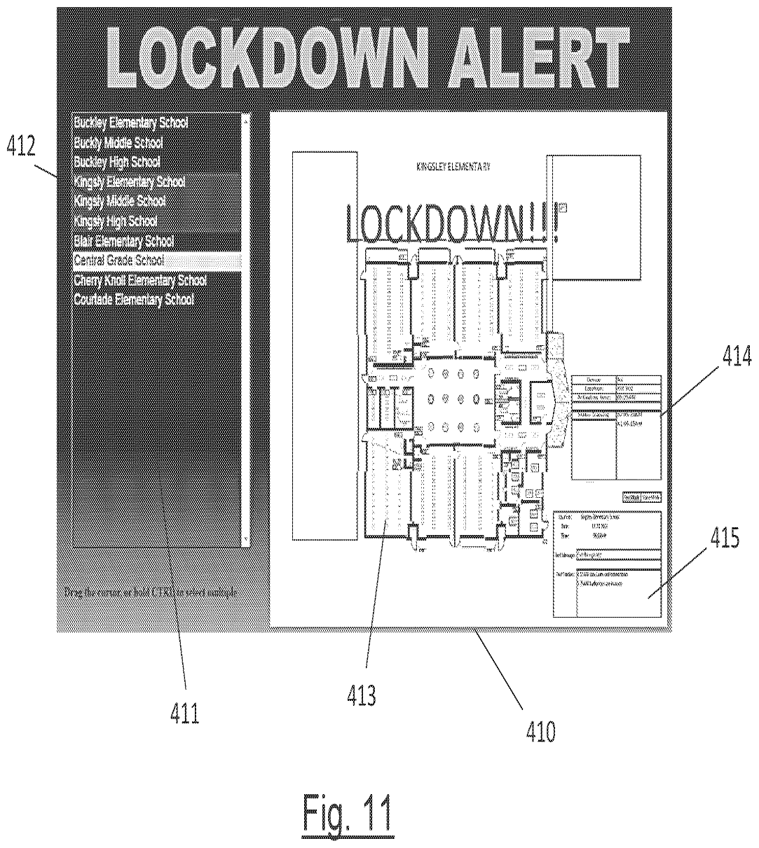

Turning next to FIG. 11, there is shown the exemplary form of a “Lockdown Alert” display screen 410 available to outside security personnel via the external communication and control device 320 when a lockdown is initiated in the building (e.g., 10). The same school listing described in connection with FIG. 10 is on the left-hand portion (designated at 411), showing which schools are in lockdown (those highlighted in red 412), while the right-hand portion depicts a floor plan 413 of the building showing the location and current status of all smart light fixtures 70, 80, 90, etc. and room lockdown components 30, 40, etc. in the building, thereby providing a visual indication of which boots 40 have been removed from their boxes 30, providing a visual indication of which light fixtures 70, 80, 90, etc. have undergone a color change. The particular floor plan 413 displayed may be varied by the outside security personnel by selecting one of the schools from the listing 411. For the sake of consistency with the PCC and secondary displays 120 and 220, the boots 40 which are not deployed are colored green in the display, while those which have been deployed and are in lockdown status are colored red. For the smart light fixtures 70, 80, 90, etc., the right-hand portion of display 410 shows if a light fixture has been activated or not; i.e., whether the color of the light fixture has been changed in any manner from normal light, as described above.

Also in the right-hand portion of the display 410 is provided a lockdown-device status-tracker display 414 which functions to provide a textual, time-stamped entry showing the current status, and subsequent status changes in, all smart light fixtures 70, 80, 90, etc. and room lockdown components 30, 40, etc. in the building.

Also in the right-hand portion of the display 410 is provided a text-and-voice notification display 415. Authorities or other personnel in control of the external communications and control device 320 can send text messages to all or selected ones of the PCC and/or secondary communication and/or control devices 120, 220. This is accomplished from the interface of the external communication and control device 320, which is programmed to be in selective communication via text and/or voice with all such devices 120, 220 in the affected building. Using conventional technology, the BLE mesh network of the smart lighting grid 100 cannot transfer audio from the external communication and control device 320 to any of the PCC or secondary devices 120, 220. Only direct text communication or text-to-voice communication is possible. Accordingly, the devices 120, 220 may be programmed to be able to convert to voice any text messages from the external communication and control device 320.

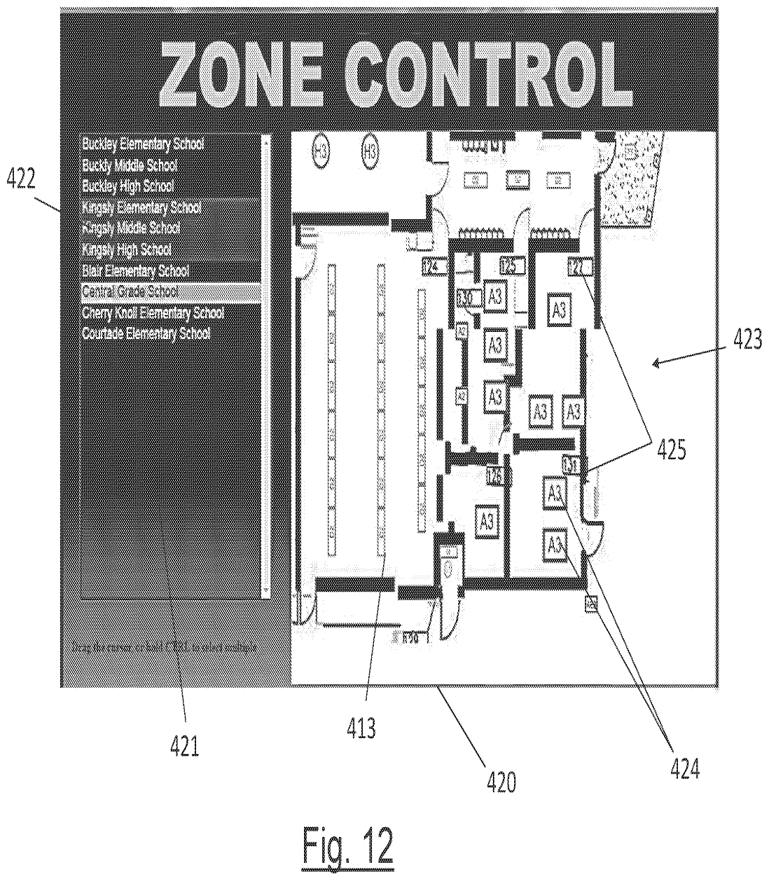

Turning next to FIG. 12, there is shown the exemplary form of a “Zone Control” display screen 420 available to outside security personnel via the external communication and control device 320 when a lockdown is initiated in the building (e.g., 10). The same school listing described in connection with FIGS. 10 and 11 is on the left-hand portion (designated at 421), showing which schools are in lockdown (those highlighted in red 422), while the right-hand portion depicts a floor plan 423 of the building showing the location and current status of all smart light fixtures (for example as shown at 424) and room lockdown components (for example as shown at 425) in the building, thereby providing a visual indication of which boots 40 have been removed from their boxes 30, as well as providing a visual indication of which light fixtures 70, 80, 90, etc. have undergone a color change.

Outside security personnel can interact with the floor plan 423 by touching (when the display is via a touch-screen type device, such as a smartphone, tablet computer, etc.) or designating via a mouse individual lockdown components (e.g., 425) and/or smart light fixtures (e.g., 424) in order to change their status from green to red and/or lockdown to “all clear.”

While initiation of lockdown via external authorities may be prompted via any known means, including the presence on-site of one or more authorities who report an incident mandating lockdown initiation, it is contemplated in one embodiment of the present invention that the “smart room light fixtures” may be equipped with microphones programmed to detect the occurrence of one or more gunshots and to relay such occurrence, through the smart lighting grid, to the PCC device 120 and the external communication and control device 320. By way of example, any of the display screens heretofore described in FIGS. 10 and 11 may be programmed to provide a visual and/or audible indication that one or more gunshots have been detected and, moreover, to indicate (such as in the floor plan 413) the specific smart light fixture or fixtures which detected the gunfire.

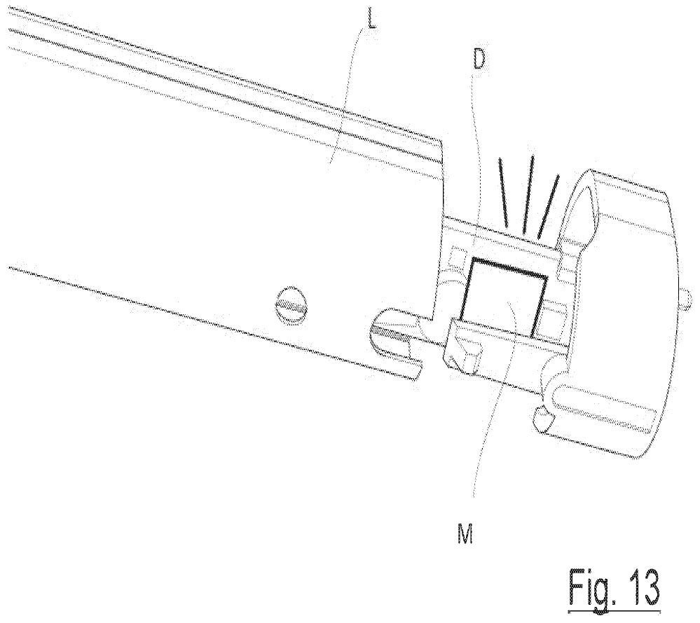

One such shot-detection technology that may be incorporated into the smart light fixtures of the present invention is commercially available through SHOTSPOTTER (Newark, California). In FIG. 13 there is shown an exemplary method for mounting a microphone M in one of light fixtures 70, 80, or 90 in the grid.

Optionally, the external communication and control device 320 of the present invention has a “drill” mode. This has all the same functionality as the lockdown mode described above, except all involved persons (both outside authorities and people in the affected building) are aware it is a drill rather than real lockdown. According to the illustrated embodiment, selection of “drill” mode is made at the PCC device 120 by building personnel.

According to one form of the invention where the external communication and control device 320 is operative to control the smart lighting grid 100 in the manner heretofore described, it is contemplated that each at least one PCC device 120 in the building 10 is unable to effect an “all clear” signal except (1) when the system is in “test” mode (i.e., when there is not a real threat in the building) or (2) when authorized by the outside security personnel (such as, for instance via a password or other code provided by the outside security personnel to the person in possession of the PCC device 120). Alternatively, or in addition, the external communication and control device 320 is operative to effect an “all clear” signal. As willbe appreciated, the rationale behind optional feature of the inventive system is to avoid the scenario where an intruder or other unauthorized person takes control of a PCC device 120 to effect an improper “all clear” signal.

While the components of the lockdown system are shown above in association with individual room doors, the above examples and the term “room” should be construed to include groups of rooms in the building closed by a common door or set of doors, for example in a wing or hallway accessed and secured by a single door or set of doors. In contrast, “common areas” as used herein is intended to refer to areas other than “rooms” as so defined.

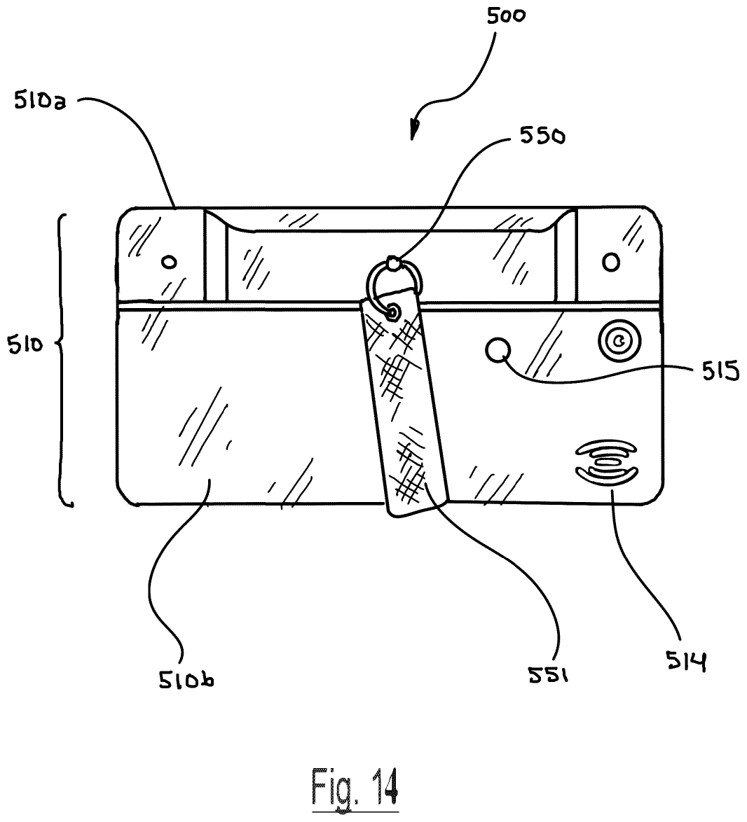

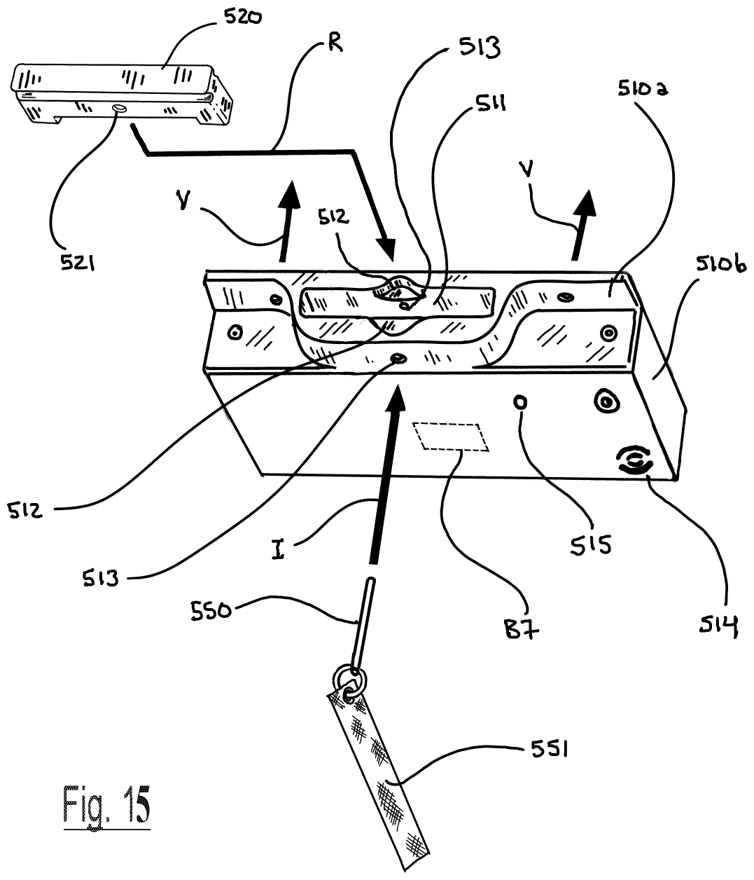

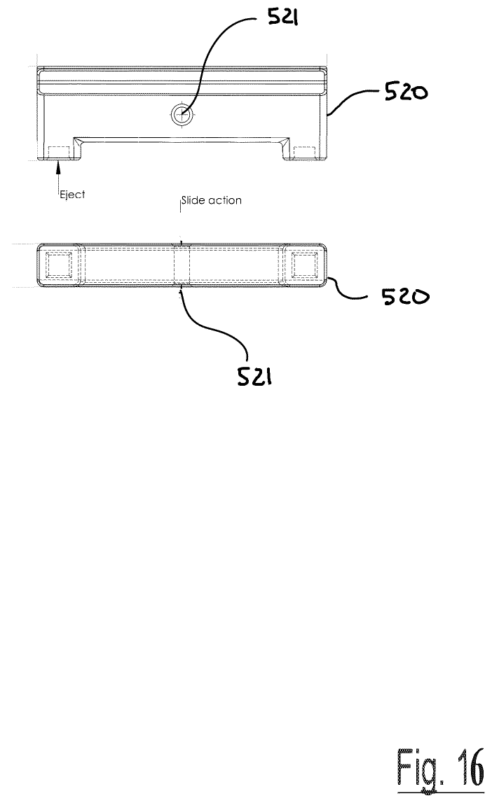

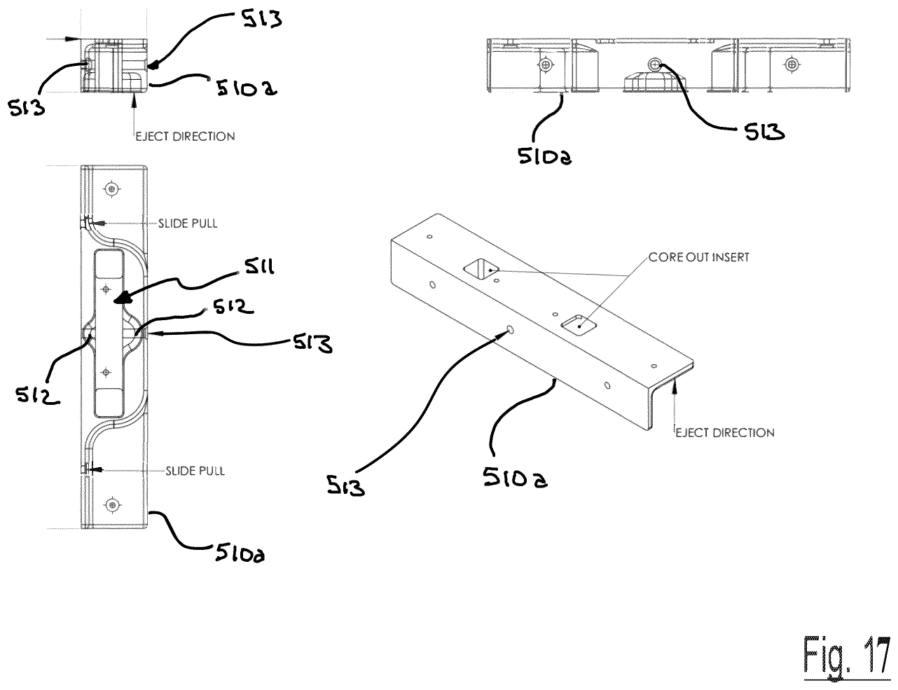

Referring now to FIGS. 14-17, there is shown in an exemplary embodiment a lockdown initiation device 500 according to the present invention. The device 500 generally comprises a body 510 and a pull or contact member 520 which is moveable relative to the body 510. The device 500 is adapted, by suitable means, to be mounted (identified by arrows V in FIG. 15 depicting the mounting direction) to a desired support surface, such as a vertical support surface (e.g., wall in the building). To this end, any suitable conventional attachment means (screws, bolts, adhesives, etc.) may be employed.

Contact member 520 is slidingly received (as indicated by arrow R in FIG. 15) in a correspondingly-shaped opening 511 in body 510. Recesses 512 defined on opposite sides of the opening 511, and in communication therewith, facilitate manually grasping the contact member 520 when it is disposed in the opening 511.

Per the illustrated embodiment, body 510 is comprised of separate components, including a first portion 510a which accommodates the contact member 520, and a housing portion 510b which houses components such as the speakers, lights, one or more sensors, switch, one or more batteries, and any associated electronics such as circuit boards, all described further below. First portion 510a is fixedly connected to housing portion 510b.

The interconnection between the contact member 520 and the body 500 is such that, upon movement of the contact member 520 relative to the body 510, the device 500 is activated to signal initiation of a lockdown event. That interconnection may take the form of a switch (not shown) that is mechanical or electrical, including for instance a magnetic switch. Preferably, though not necessarily, the switch is configured or selected so that the contact member 520 closes the switch to activate the device to signal initiation of a lockdown event.

First portion 510a includes an opening 513 and contact member 520 includes a corresponding opening 521. Opening 513 extends through the first portion 510a on both sides of, and communicates with, opening 511. Opening 521 extends completely through contact member 520. Openings 513 and 521 are dimensioned to receive a pin 550. Pin 550 may include a handle 551 in the form of a sturdy tag or ribbon secured to the pin 550. The positioning of each of opening 513 in first portion 510a and opening 521 in contact member 520 are such that, when contact member 520 is positioned in opening 511 so that openings 513 and 521 are aligned, contact member 520 does not make contact with body 510 to close the switch and, therefor, the device 500 is not activated to signal initiation of a lockdown event. To maintain this condition, pin 550 is inserted through (indicated by arrow I in FIG. 15) and positioned in openings 513 and 521, holding contact member 520 in position in the opening 511. Conversely, when pin 550 is removed by manually pulling on the handle 551, contact member 520 is free to move downwardly within the opening 511 and into contact with the body 510 to close the switch.

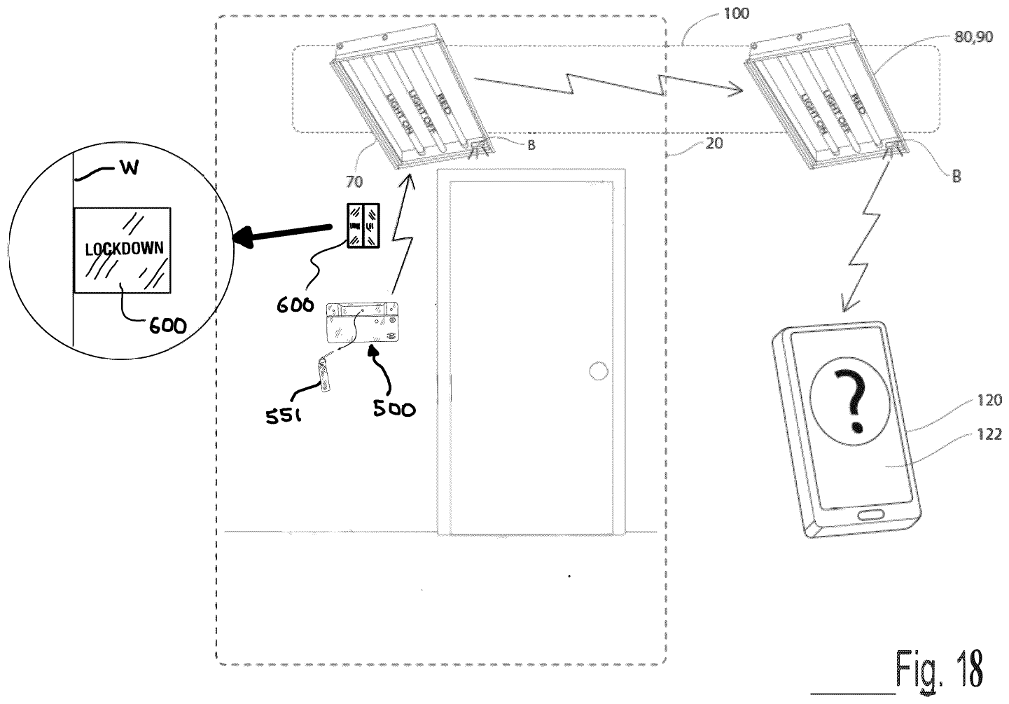

Body 510 includes at least one sensor, such as BLE sensor B7, which is operatively connected to the switch so as to be activated when the switch is closed (e.g., upon movement of the contact member 520 relative to the body 510, in the manner herein described, when pin 550 has been removed from the openings 513 and 521). Sensor B7 may be powered by one or more batteries (not shown) contained in the body 510 and, more particularly, the housing portion 510b thereof. Sensor B7 is operative to communicate one or more state-indicating signals indicating when the lockdown initiation device is activated by closure of the switch. This may include communicating with other components of the system (e.g., lights, PCC device, boxes, etc.) as described above. Consequently, sensor B7 may, for instance, communicate activation of the associated lockdown initiation device 500 to the PCC device 120 via the smart lighting fixtures of lighting grid 100, as shown in FIGS. 18-20. It is envisioned that communication may be effected to the lockdown initiation devices arranged throughout the building so that they all may be effected to automatically signal initiation of a lockdown event when any one of them has first been manually activated to signal initiation of a lockdown event.

It is further contemplated that the sensor B7 may be operative to communicate directly with others of the lockdown initiation devices arranged throughout the building, such as via a mesh-type network.

Signaled initiation of a lockdown event may take the form of sounds and/or illumination provided by the device 500 itself, such as through one or more of speakers 514 and/or lights 515 mounted in the body 510 (and, more specifically, the housing portion 510b). These components may be powered by one or more batteries (not shown) contained in the housing portion 510b. These components may, optionally, be actuated by the sensor B7, or via circuitry operatively connected to the switch. Alternatively, or in addition, signaled initiation of a lockdown event may comprehend communication through the wireless communication network of the one or more state-indicating signals to effect sound and of lights from other devices that may be included in the system, such as the smart lighting fixtures of the lighting grid 100.

In one embodiment, the device 500 may be operative to selectively provide illumination in one or more colors via the one or more lights 515, the one or more colors at least including a color that that has been predesignated to notify persons in the building that a lockdown event has been initiated (“the notification color”). The one or more colors may further include at least a color that that has been predesignated to notify persons in the building that a lockdown event has been terminated (“the ‘all clear’ color”).

The lockdown initiation device as heretofore described is, in one embodiment, utilized in a building security system where a plurality of such lockdown initiation devices are positionable in the building in one or more of the one or more rooms and/or the common areas exterior of the one or more rooms. As discussed, the plurality of lockdown initiation devices are each independently manually activatable to signal initiation of a lockdown event and to communicate, via a wireless communication network, one or more state-indicating signals indicating when the lockdown initiation device has been manually activated to signal initiation of a lockdown event. Each of the lockdown initiation devices is also operable to automatically signal initiation of a lockdown event when any one of the other lockdown initiation devices communicates the one or more state-indicating signals indicating that lockdown initiation device has been manually activated. This may include the aforementioned lights and/or sounds. Alternatively, or in addition, it may comprehend communication through the wireless communication network of the one or more state-indicating signals to effect sound and of lights from other devices that may be included in the systems, such as the smart lighting fixtures of the lighting grid 100.

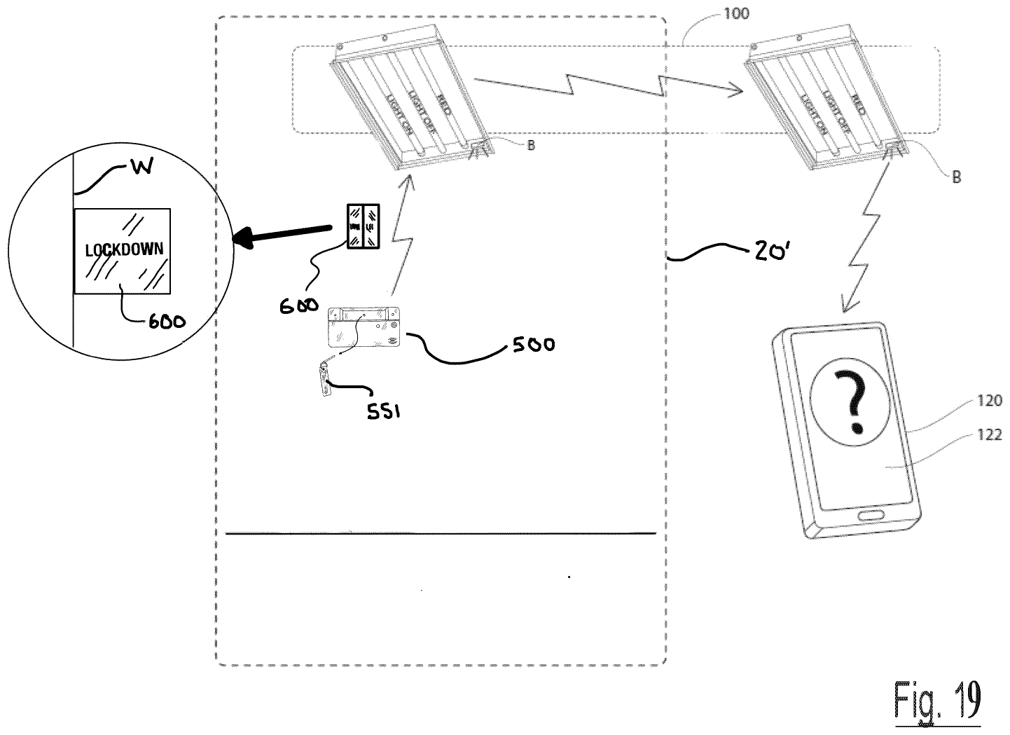

It is contemplated that the lockdown initiation devices may be used in lieu of, or in combination with, the room lockdown components as described above. That is, the lockdown initiation devices may be incorporated into the system herein described as an additional means of initiating a lockdown. In such employment, they might advantageously be positioned in common areas 20′ such as hallways or the like. This exemplary embodiment is shown in FIG. 19.

Alternatively, it is contemplated that the lockdown initiation devices may be utilized in the system herein described in lieu of the room lockdown components—and particularly the boot box 30 and boot 40. In such employment, they might advantageously be positioned at least in rooms 20 to the same utility and advantage as the boot box 30 and boot 40; except that the signaled initiation of a lockdown event would prompt persons in the building to lock or barricade the doors of their rooms in alternative ways (e.g., door locks or other barricading measures). This exemplary embodiment is shown in FIG. 18.

Still referring to FIGS. 18 and 19, is contemplated that the location of each lockdown initiation device in the building is at least identified via signage 600 positioned proximate the device 500. As shown in the detailed view at left, which shows the signage from a side view, the signage 600 extends from the wall W or other vertical support surface so as to increase the visibility of the signage to persons in the building.

It will be appreciated that the virtual room map 200 of the school building (or other building) discussed in connection with FIGS. 5-7, and the display screens discussed in connection with FIGS. 10-12, will also preferably comprehend the location (e.g., in one or more rooms and/or common areas) and status of the lockdown initiation devices described herein, such that one may know the location and condition of the lockdown initiation devices in a building, as well as whether any of them has been activated to initiate a lockdown of the building. In other words, the system will map the locations of the lockdown initiation devices and provide graphical indications of their status in response to changes in that status depending on whether the lockdown initiation devices, or any of them, have been activated to initiate a lockdown.

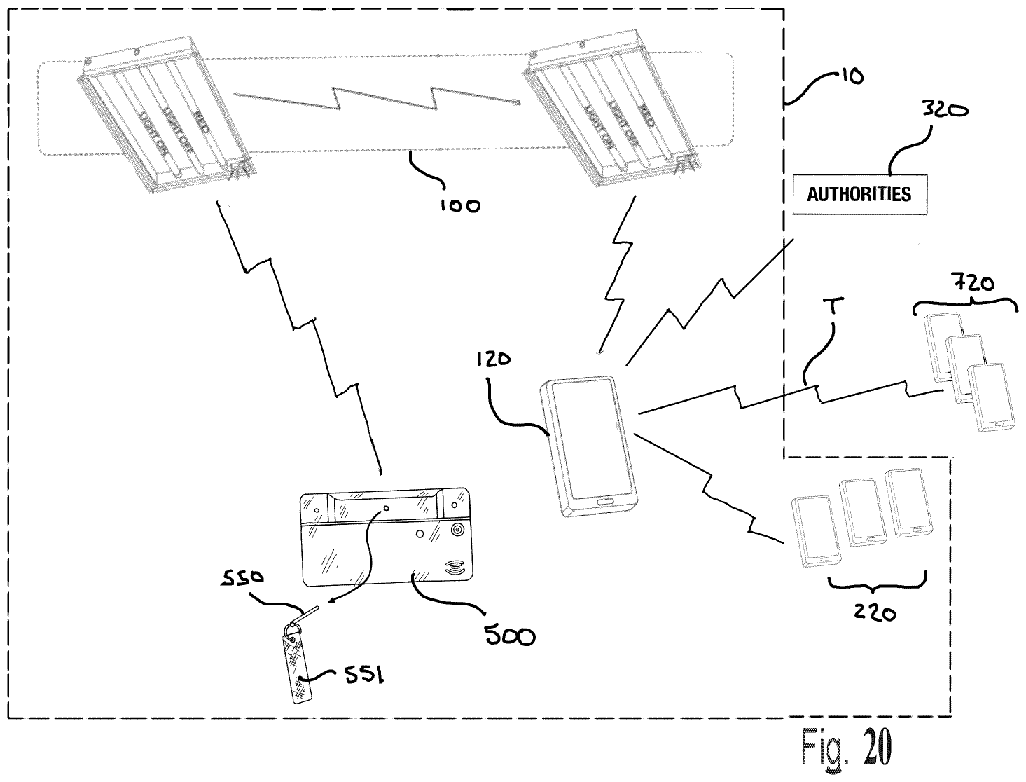

In one embodiment, exemplified in FIG. 20, the system of the present invention provides a computerized database list of contact details for the personal communication devices (e.g., mobile phones 720) for designated recipients of information related to building security conditions. These recipients may be outside of the building 10 and to this extent are distinguishable from lower-tier personnel in the building whose receipt of notifications via secondary wireless communication and/or control devices 220 is discussed elsewhere herein.

By conventional means, this contact information can be utilized to provide text messages to the designated recipients. More particularly, upon the signaled initiation of a lockdown event, such as via activation of a lockdown initiation device in the manner herein described (this is schematically depicted in FIG. 20 by the transmission of signals from the lockdown initiation device 500 to the PCC 120 via the lighting grid 100), the system is operative to automatically send a text message to the personal communication devices 720 of the predefined list of recipients, as identified schematically by the line T in FIG. 20. In an exemplary embodiment, the text message identifies at least an identifier of the building where the lockdown was initiated, as well as an identifier of the room or common area containing the lockdown initiation device from which the lockdown was initiated.

Depending on the particular lockdown protocol for the building, it is also contemplated that notification may also provided to the “authorities” 320 and lower-tier personnel communication devices 220, as exemplified in FIG. 20.

Upon the conclusion of a lockdown event, such as determined by the authorities and indicated via the PCC, for instance, the system is further operative to automatically send a text message to the personal communication devices of the predefined list of recipients indicating that the lockdown event has been concluded. In an exemplary embodiment, the text message identifying at least an identifier of the building where the lockdown was initiated, and an indication that the lockdown event has concluded.

In like manner to that described above for notification of the authorities via the PCC device upon initiation of a lockdown event through the boot out condition, notification of the initiation of the lockdown event via a lockdown initiation device may be automatically sent to outside authorities 320. In the exemplary embodiment, such notification includes an identifier of the building and an identifier of the room or common area containing the lockdown initiation device from which the lockdown was initiated.

It is to be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention.

It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports.

The claims are representative of the invention and are not intended to limit the claimed invention with respect to other features which are supported by or might become apparent from the description, and which might be claimed subsequently.

1. A lockdown system for use in a building including one or more rooms, each having a door providing access thereto, and common areas exterior of the one or more rooms, the lockdown system comprising:
a plurality of lockdown initiation devices positionable in the building in one or more of the one or more rooms and/or the common areas exterior of the one or more rooms, the plurality of lockdown initiation devices each being independently manually activatable to signal initiation of a lockdown event and to communicate, via a wireless communication network, one or more state-indicating signals indicating when the lockdown initiation device has been manually activated to signal initiation of a lockdown event, whereupon the signaled initiation of the lockdown event is communicated to at least one communication device and an alert notification of the initiation of the lockdown event is provided via the at least one communication device.

2. The lockdown system of claim 1, further comprising a plurality of room lockdown components positionable in one or more of the one or more rooms, the room lockdown components comprising a door-securing device that is manually deployable to a deployed condition in which the door-securing device is manually positioned to prevent opening of the door providing access to the at least one room.

3. The lockdown system of claim 2, wherein, upon manual activation, each of the plurality of lockdown initiation devices is operable to provide sounds and/or illumination to provide an audible and/or visual signal of the initiation of a lockdown event.

4. The lockdown system of claim 3, wherein further each of the lockdown initiation devices is operable to automatically and without manual activation provide an audible and/or visual signal of the initiation of a lockdown event when any one of the other lockdown initiation devices communicates, via the wireless communication network, the one or more state-indicating signals indicating that any one of the lockdown initiation device has been manually activated.

5. The lockdown system of claim 1, wherein the wireless communication network comprises:
smart light fixtures positionable inside the building, the smart light fixtures operative to:
(i) selectively provide illumination in one or more colors;
(ii) receive the signaled initiation of a lockdown event from the lockdown initiation devices, and in response thereto provide illumination in one of the one or more colors that has been predesignated to notify persons in the building that a lockdown event has been initiated (“the notification color”).

6. The lockdown system of claim 1, wherein:
the plurality of lockdown initiation devices are positionable on vertical support surfaces in the building in one or more of the one or more rooms and/or the common areas exterior of the one or more rooms; and
the system further comprising signage positionable on the vertical support surfaces vertically above each of the plurality of lockdown initiation devices, the signage dimensioned to extend outwardly from the vertical support surfaces so as to increase the visibility of the signage.

7. The lockdown system of claim 1, wherein, upon the signaled initiation of the lockdown event, a text message is automatically sent to personal communication devices of a predefined list of recipients, the text message identifying at least an identifier of the building and an identifier of the room or common area containing the lockdown initiation device from which the lockdown was initiated.

8. The lockdown system of claim 7, wherein, upon the conclusion of a lockdown event, a text message is automatically sent to the personal communication devices of the predefined list of recipients, the text message identifying at least an identifier of the building and an indication that the lockdown event has concluded.

9. The lockdown system of claim 1, wherein, upon the signaled initiation of the lockdown event, notification of the initiation of the lockdown event is automatically sent to outside authorities, the notification including an identifier of the building and an identifier of the room or common area containing the lockdown initiation device from which the lockdown was initiated.
